(19) United States
(12) Patent Application Publication
(10) Pub. No.: US 2024/0129496 A1
(43) Pub. Date: Apr. 18, 2024

(54) METHOD AND SYSTEM OF VIDEO CODING WITH HANDLING OF ILLEGAL BLOCK PARTITIONS

(71) Applicant: Intel Corporation, Santa Clara, CA (US)

(72) Inventor: Tsung-Han Yang, Folsom, CA (US)

(73) Assignee: Intel Corporation, Santa Clara, CA (US)

(21) Appl. No.: 18/399,169

(22) Filed: Dec. 28, 2023

(51) Int. Cl. H04N 19/176; H04N 19/119; H04N 19/186; H04N 19/59; H04N 19/70

(52) U.S. Cl. CPC H04N 19/176; H04N 19/119; H04N 19/186; H04N 19/59; H04N 19/70

(57) ABSTRACT

Methods, systems, and articles are described herein related to video coding. The method comprises receiving compressed image data of video frames including a block of image data of at least one of the frames. The method also comprises receiving first partition data to be used to decode the compressed image data and indicating a partition in the block. This method comprises detecting whether or not the block has an illegal block partition. Also, the method comprises generating second partition data to indicate the illegal block partition of the block is to be ignored. Further, the method includes decoding the block at least according to the second partition data.

### BACKGROUND

Video coding standards or codecs provide standards for an encoder to partition blocks of image data on video frames into partitions or sub-blocks for higher efficiency during compression of the blocks of image data and better image quality. The partitions have dimensions set according to the codec standard. A remote decoder receives a video bitstream of the compressed image data and reconstructs the video frames by using the compressed blocks of image data that are received with partition syntax that indicates how the blocks were partitioned at the encoder.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Furthermore, where considered appropriate, reference labels have been repeated among the figures to indicate corresponding or analogous elements. In the figures:

FIG. 1 is a schematic diagram of an image processing system with a decoder that handles illegal video coding block partitions according to at least one of the implementations herein;

FIG. 2 is a flow chart of a method of video coding with illegal block partition handling according to at least one of the implementations herein;

FIG. 3 is a schematic diagram of video coding block partition syntax according to at least one of the implementations herein;

FIG. 4 is a schematic diagram of video coding block partitions according to the implementations herein;

FIG. 5 is an illustrative diagram of an example system;

FIG. 6 is an illustrative diagram of another example system; and

FIG. 7 illustrates another example device, all arranged in accordance with at least some implementations of the present disclosure.

### DETAILED DESCRIPTION

One or more implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein also may be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices, commercial devices such as servers, and/or consumer electronic (CE) devices such as set top boxes, smart phones, tablets, televisions, etc., may implement the techniques and/or arrangements described herein. Furthermore, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein also may be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. In another form, a non-transitory article, such as a non-transitory computer readable medium, may be used with any of the examples mentioned above or other examples except that it does not include a transitory signal per se. It does include those elements other than a signal per se that may hold data temporarily in a “transitory” fashion such as RAM and so forth.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Furthermore, when a particular feature, structure, or characteristic is described in connection with an implementation, it is submitted that it is within the knowledge of one skilled in the art to effect such feature, structure, or characteristic in connection with other implementations whether or not explicitly described herein.

Systems, articles, and methods are described below related to method and system of video coding with handling of illegal block partitions according to the implementations herein.

A number of different video compression codecs exist that specifies partition block sizes for video coding, one such codec is AOMedia Video 1 (AV1), which is a currently (2023) open, royalty-free video coding format. AV1 will be used as the example codec herein, and particularly for AV1 4:2:2 chroma subsampling format, although other codecs and chroma subsampling formats could be used instead. The specification of AV1 can be found at https://github.com/AOMediaCodec/av1-spec/releases.

When an encoder is using a codec, such as AV1, the encoder typically divides a video frame into block sizes, referred to as partitions, according to that specified by the codec standard and for prediction which generates residuals or changes in image data between an original version of a frame and a simulated decoded frame determined by a decoding loop at the encoder. Then, the image data can be transmitted in a bitstream to a decoder, and used to reconstruct the video frames. Thus, the image data may include video coding layer data such as the image luminance and color pixel values, as well as intra and inter prediction data, filtering data, residuals, and so forth so that the luminance and color data of each and every pixel in all of the frames need not be placed in the bitstream from encoder to decoder.

The video coding layer also may include partition syntax that indicates the partitions to be used with individual large pixel blocks, referred to as superblocks in AV1 codec, and the subblocks of the large blocks. These partition syntax are compressed and placed in headers of the image data of the superblocks (superblock level versus frame level). The image data of the superblocks and subblocks also is often compressed and packeted in a bitstream in an order that indicates the partitions used in the superblock.

The illegal partition sizes can result from a number of different situations. By one form, the codec being used at the decoder should be the same codec used at the encoder. Thus, at the encoder, in some cases the partitions being used may not be completely compatible with codec used at the decoder, and the encoder may use illegal block partition sizes that are not permissible with a specified chroma subsampling format and the codec at the decoder, here being AV1 codec. Otherwise, while the bitstream is being transmitted over the internet, corruption within the bitstream might occur that changes the values of the partition syntax. This can occur due to overloaded network connections or malicious hacking attacks for example. In this case, an illegal partition split may then occur during decoding of the corrupted bitstream. This corruption can lead to dropping video frames and degrading video quality. The corruption also may suspend the whole video decoding system (or in other words, hang). Thus, the hang may deteriorate the user experience as the system goes to a reset sequence.

To resolve these issues, the presently disclosed method and system detects illegal prediction partition block sizes that are illegal according to a codec being used for video coding. In this case, the system and method overrides the illegal syntax code thereby providing a more resilient video coding system, which therefore provides a better user experience. The example methods described herein can be implemented in software, firmware and/or hardware that operates codec on a decoder, and particularly decode partition function code that uses partition syntax to set the partitions for blocks of image data at the decoder. In one form of the present method and system, the decode partition function code may have instructions to detect and ignore the illegal partition syntax received in the bitstream with the compressed image data, and use a different legal or corrective partition syntax instead. By one form, the corrective partition syntax indicates a large block of image data is not to have any partition. This partition none syntax is used instead of other partition patterns for the large block because this implementation involves the least amount of data in a superblock overhead By one form, the partitions are used for prediction, and the decoder then can proceed with prediction without causing errors or a bad user experience due to the illegal partition. It should be noted that the terms syntax and partition can be used herein as singular or plural.

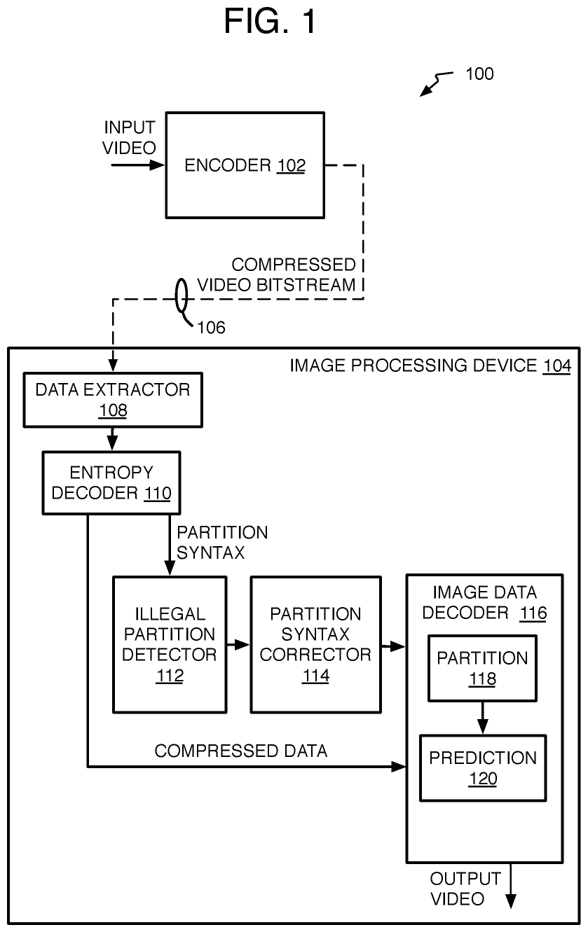

Referring now to FIG. 1 for more detail, an example image or video processing system (or video coding system) 100 may be used to perform the methods of video coding with illegal partition handling described herein. The system 100 may have an image or video processing device also referred to as an encoder device or just encoder 102 that can transmit a bitstream 106 of compressed video frames to a decoding image processing device or decoder 104. The encoder system 102 may receive input video in the form of frames (also referred to as images or pictures) of a video sequence such as frames of image data pre-processed to have a particular color sampling format such as 4:2:2, and otherwise in a format ready for encoding by an encoder using a video coding codec such as AV1 for example.

The encoder 102 may operate according to AV1 or other codec syntax and functions accessible to the encoder and that may have partition syntax indicating the available partition sizes to divide large blocks or superblocks of image data. The partitions discussed herein are prediction partitions used to perform inter or intra prediction on the superblocks and its subblocks to generate residuals to be compressed with a bitstream, although other types of partitions could be handled instead. Once or as the compressed superblocks (or residuals therefor) are being compressed and placed in bitstream packets, the partition syntax used for each large block (or superblock) and its subblocks also may be placed in the header of each large block (e.g., a superblock-level or layer). The compressed video bitstream 106 is then transmitted to the decoder.

At the decoding side, the device (or decoder) 104 may have a data extractor 108, an entropy decoder 110, an illegal partition detector unit 112, a partition syntax corrector unit 114, and an image data decoder unit 116 that has at least a partition unit 118 and a prediction unit 120. The prediction unit 120 may have an in verse quantization unit, an inverse transform unit, an intra-prediction unit and inter-prediction unit (not shown) including a motion compensation unit that uses either motion vectors obtained from the bitstream or performs its own motion estimation.

In operation, the data extractor 108 may have hooks or other known mechanisms to extract and separate the superblocks of image data and partition syntax, and this may involve counters, and/or a data shifter. The bitstream data of superblocks may be placed in a buffer until the entropy decoder 110 is ready to decode the image data superblocks. The entropy decoder 110 also entropy decodes the partition syntax by using context-adaptive binary arithmetic coding (CABAC) algorithms or other algorithms specified in the AV1 or other codec specification in this example. the entropy decoded image data may be provided to the image data decoder unit 116, while the partition syntax is first provided to the illegal partition detector unit 112.

The illegal partition detector unit 112 may run decode partition function code of the codec, here being AV1, and for the color subsampling format, here 422, being used. By one form, the detector unit 112 receives or obtains the size of the current block being analyzed as well as the partition syntax that was retrieved from the bitstream and is assigned to the current block for partitioning. The current block may be the superblock (128×128 pixels for example) or one of its sub-blocks such as 64×64, 32×32, 116×16, or 8×8 pixels. Once the size of the current block being analyzed and its initial or first partition syntax is obtained, the first partition syntax can be compared to the illegal partitions for that block size.

A partition syntax corrector unit 114 then may change the partition syntax of the current block if the first partition syntax is an illegal partition (or in other words, has an illegal partition pattern). By one form, the partition is changed to ignore the first partition syntax and set so that no partitioning of the current block will be performed. Thus, the current block will be decoded as a single block or together in its entirety and this may be signaled by a corrective or second partition syntax that indicates partitioning of the current block should be omitted.

It will be understood that the detection and corrector units 112 and 114 may be a single unit that operates decode partition function code that uses partition syntax as part of the decoder's operations to set a legal partition for each or individual block being used for inter-prediction.

Partition unit 118 next may use the corrective partition syntax (or other syntax if the first partition was legal) to partition the current block, and provide the partitioned blocks for inter-prediction at the decoder by the prediction unit 120 as well as any of the other units that use the blocks.

In some examples, system 100 may include additional items that have not been shown in FIG. 1 for the sake of clarity. For example, the encoder may include units or modules for the prediction block partitioning itself, residual generation, transform block partitioning, quantization, and entropy coding, and with a decoding loop that may include inverse quantization and transform, residual addition and block reconstruction, loop filters, motion estimation, motion compensation, intra-prediction, and so forth. In addition to the units mentioned above, the decoder 104 may include other units or modules as well such as filters. Also, video coding system 100 may include processor circuitry providing at least one processor, a radio frequency-type (RF) transceiver, splitter and/or multiplexor, a display, and/or an antenna. Further, video coding system 100 may include additional items such as a speaker, a microphone, an accelerometer, memory, a router, network interface logic, and so forth. Such implementations are shown with system 500, 600, or 700 described below.

As used herein, the term “coder” may refer to an encoder and/or a decoder. Similarly, as used herein, the term “coding” may refer to encoding via an encoder and/or decoding via a decoder. A coder, encoder, or decoder may have components of both an encoder and decoder.

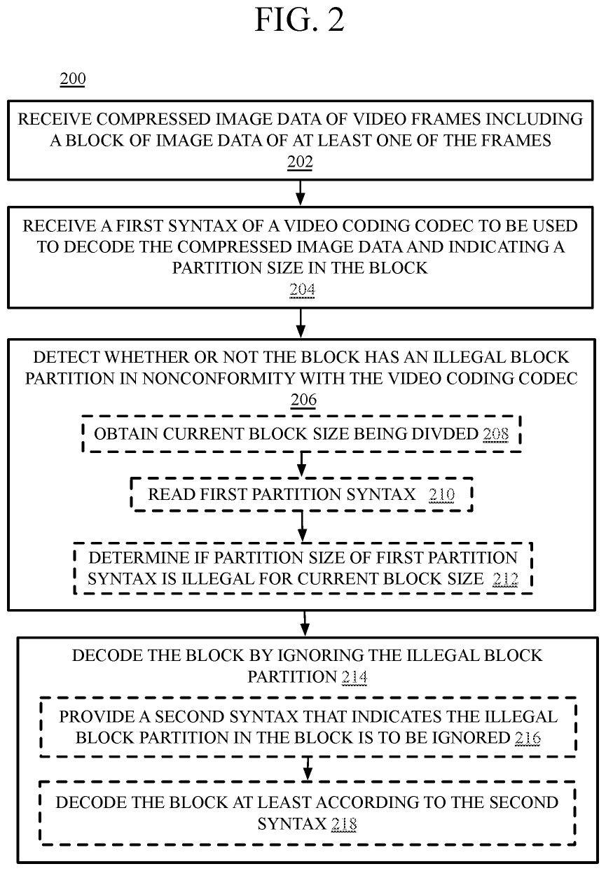

Referring to FIG. 2, an example process 200 for video coding with illegal partition handling is arranged in accordance with at least some implementations of the present disclosure. In the illustrated implementation, process 200 may include one or more operations, functions or actions as illustrated by one or more of operations 202 to 218 numbered evenly. By way of non-limiting example, process 200 will be described herein with reference to operations discussed with respect to example systems 100, 500, 600, or 700 of FIGS. 1 and 5-7 respectively, and where relevant.

Preliminarily, an encoder may receive the image data to be encoded in the form of a sequence of video frames, and the image data of the frames may be pre-preprocessed to format the image data for more efficient video coding. This may include demosaicing such as for 422 chroma subsampling format, de-noising, and so forth. The pre-processing also may or may not include processes that convert the image data to certain color spaces (such as from RGB to YUV) for better coding efficiency.

The encoder then may compress the image data in accordance with a codec, such as AV1, and that generates partition syntax as the encoder performs prediction by deciding which partitions to use on blocks of the image data. The partition syntax is then also entropy encoded.

The encoder then places the compressed image data and the partition syntax into bitstream packets. The partition syntax that was used for a large block (or superblock) may be placed in the header of the associated large block. This includes partition syntax of any partition syntax for the subblocks of the large block. Thus, the partition syntax is placed in the same bitstream as the compressed imaged data.

The bitstream of compressed video frame or image data along with the compressed partition syntax is then transmitted for wired or wireless transmission to a decoder. The units capable of providing such transmission are mentioned below. Such transmission may be through any desired wide area network (WAN) such as the internet, local area network (LAN), personal area network (PAN), or even within the same device.

Process 200 may include “receive compressed image data of video frames including a block of image data of at least one of the frames” 202. Now at a decoder side, a decoder or image processing device with a decoder may have a receiver or transceiver unit to receive the bitstream on a wired network or wirelessly. This may include receiving large image data blocks of a frame of the compressed video sequence, and for AV1 codec superblocks at 128×128 pixels. The decoder may extract the coded image data. This also may include placing the data in buffers or other memory until needed.

Process 200 may include “receive a first syntax of a video coding codec to be used to decode the compressed image data and indicating a partition size in the block” 204. This first involves having syntax such as the partition syntax extracted from the bitstream, and separated from the image data by using a de-multiplexer for example. The decoder then may perform entropy decoding to decode the partition syntax and then read the partition syntax to perform decode functions. Specifically, the decoder runs a decode partition function of the codec, here being AV1, and specifically found at Decode Partition Syntax within the stored codec at the decoder. It will be understood that the term ‘syntax’ here can refer to a single code in the codec (or plural codes as mentioned above) or to a routine or function within the codec depending on the context. Here, the partition syntax is a single code that refers to a partition pattern that is used by a decode partition function to set the partitions for blocks of image data.

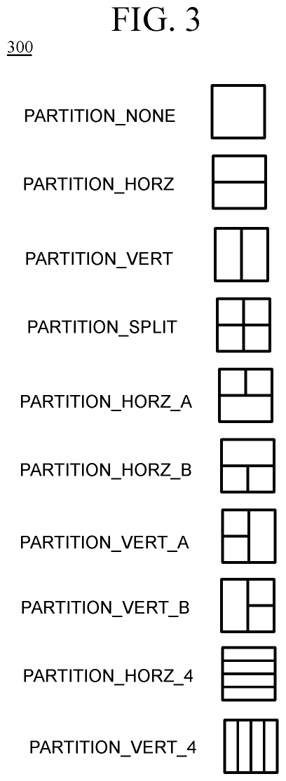

Referring to FIG. 3, a list 300 of partition syntax available on AV1 codec and indicating partition or subblock patterns is as follows on Table 1 and as shown on FIG. 3.

TABLE 1
Available Partition Syntax on AV1 Codec

| | |
|---|---|
| PARTITION_NONE | Block cannot be divided |
| PARTITION_HORZ | Block is horizontally divided into two blocks (one |
| | over the other). |
| PARTITION_VERT | Block is vertically divided into two blocks (side by |
| | side). |
| PARTITION_SPLIT | Block is divided into four quadrant blocks and |
| | decoding logic recurrently checks for partition again. |
| PARTITION_HORZ_A | Horizonal split and the top partition is split again |
| PARTITION_HORZ_B | Horizonal split and the bottom partition is split again |
| PARTITION_VERT_A | Vertical split and the left partition is split again |
| PARTITION_VERT_B | Vertical split and the right partition is split again |
| PARTITION_HORZ_4 | Block is horizontally divided into four equal blocks. |
| PARTITION_VERT_4 | Block is vertically divided into four equal blocks. |

The partition syntax on Table 3 is shown on FIG. 3 and may be the same or different on other codecs that may be used with the present method and system here instead.

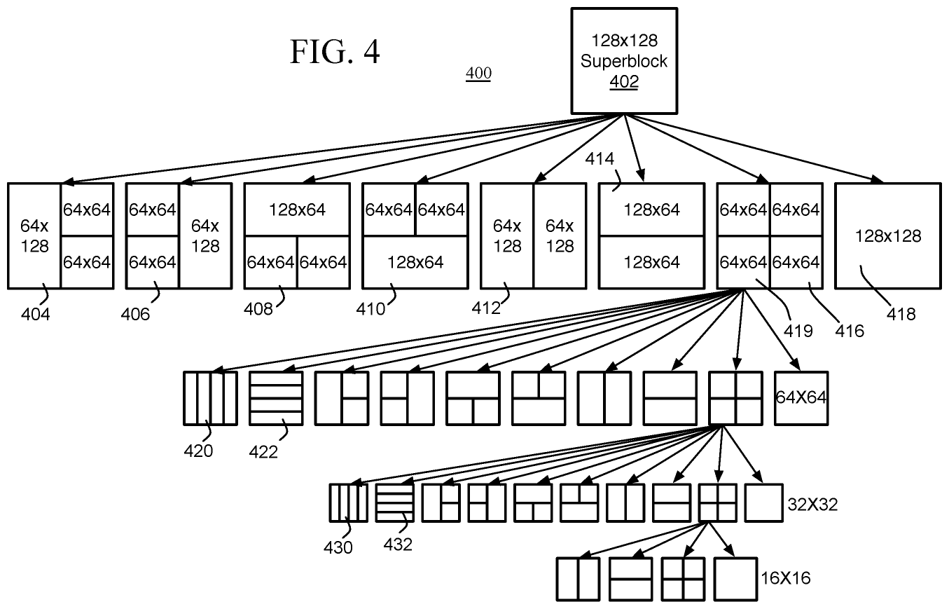

Referring to FIG. 4, process 200 may include “detect whether or not the block has an illegal block partition in nonconformity with the video coding codec” 206. The available or legal blocks may be different depending on the block size to be partitioned and the chroma subsampling format. Generally for AV1 codec, a partition diagram 400 shows the available legal partition (or partition syntax) depending on the block size and block partition of a parent block (whether a superblock or subblock of a superblock).

Specifically for AV1, and disregarding the illegal partitions for a certain chroma subsampling format for now, a superblock 402 may be partitioned into eight of the partition patterns shown on FIG. 3, here numbered evenly from 404 to 418, and except for the PARTITION_VERT_4 and PARTITION_HORZ_4 patterns. The pixel sizes of the subblocks are as shown.

When a PARTITION_SPLIT 416 is decoded from the bitstream, the block is equally divided into four quadrant subblocks 419. Each subblock 419 of a split then becomes the parent block and may be partitioned again. This is repeated until the block is the smallest allowed size, or a PARTITION_NONE is decoded from the bitstream. All splits other than PARTITION_SPLIT and PARTITION_NONE will divide the blocks according to their respective partitioning configurations but will not recursively be re-partitioned.

In the present example, it is shown split subblock 419 may be partitioned into any of the 10 available partition syntax including the PARTITION_VERT_4 420 and PARTITION_HOR_4 422 patterns. The split pattern subblocks at the 64×64 level (which is now a 32×32 block) can be partitioned as well into any of the 10 partition syntax patterns including patterns 430 and 432. The split partitions of the previous subblocks can be split again to the 16×16 level, but now only four of the partition syntax or patterns is available including PARTITION_NONE, PARTITION_SPLIT, PARTITION_HORZ, AND PARTITION_VERT. In some codecs, the 16×16 partition split subblocks can be split again to an 8×8 level and then again to a 4×4 level with various legal partition patterns.

The decoding may proceed by performing a recurrent function such as decode partition when the superblock is received and then again for each split subblock (or other block authorized to be partitioned) to be further partitioned when such further partitioning is available according to FIG. 4 for example.

As to the illegal partition syntax, this also depends on the chroma subsampling format being used, which here is 422 in the present example. For bitstream conformance in AV1, it is determined whether or not get_plane_residual_size(subSize, 1) is not equal to BLOCK_INVALID, which occurs when the block size, and in turn partition syntax, is illegal. This check attempts to limit the chroma UV blocks (of a YUV color scheme), and in turn transform blocks, from being too tall or too wide (i.e., having aspect ratios outside the range 1:4 to 4:1). However, a stream corrupted during transmission or incorrectly generated by the encoder may not conform to this specification.

Here, for 422 chroma subsampling format, the sizes of partition syntax identified as invalid or illegal in the AV1 specification are on Table 2 below.

TABLE 2
Illegal partition Syntax for 4:2:2 format on AV1 Codec

| Invalid 4:2:2 Child Size | Parent Size | Illegal Split |
|---|---|---|
| 4 × 8 | 8 × 8 | PARTITION_VERT |
| 4 × 8 | 8 × 8 | PARTIAL VERT |
| 8 × 16 | 16 × 16 | PARTITION_VERT_A |
| 8 × 16 | 16 × 16 | PARTITION_VERT_B |
| 8 × 16 | 16 × 16 | PARTITION_VERT |
| 8 × 16 | 16 × 16 | PARTIAL VERT |
| 16 × 32 | 32 × 32 | PARTITION_VERT_A |
| 16 × 32 | 32 × 32 | PARTITION_VERT_B |
| 16 × 32 | 32 × 32 | PARTITION_VERT |
| 16 × 32 | 32 × 32 | PARTIAL VERT |
| 32 × 64 | 64 × 64 | PARTITION_VERT_A |
| 32 × 64 | 64 × 64 | PARTITION_VERT_B |
| 32 × 64 | 64 × 64 | PARTITION_VERT |
| 32 × 64 | 64 × 64 | PARTIAL VERT |
| 64 × 128 | 128 × 128 | PARTITION_VERT_B |
| 64 × 128 | 128 × 128 | PARTITION_VERT_A |
| 64 × 128 | 128 × 128 | PARTITION_VERT |
| 64 × 128 | 128 × 128 | PARTIAL VERT |
| 4 × 16 | 16 × 16 | PARTITION_VERT_4 |
| 8 × 32 | 32 × 32 | PARTITION_VERT_4 |
| 16 × 64 | 64 × 64 | PARTITION_VERT_4 |

Continuing with the decoding, operation 206 may include “obtain current block size being divided” 208, “read first partition syntax” 210, and “determine if partition size of first syntax is illegal for current block size” 212. Thus, to limit the amount the decoding system hangs or drops video frames, decoding logic or the decoder compares the first partition syntax to the illegal partitions of the parent block size, and this is repeated for each superblock and subblock of the superblock that can have partitions. A s described below, in one example form, the decode partition function may have the illegal partition patterns or syntax mentioned in the partition function code itself. Otherwise, such illegal sizes (or the legal sizes) may be listed in a look-up table or other memory instead for example.

Process 200 may include “decode the block by ignoring the illegal block partition” 214, and this may include “provide a second syntax that indicates the illegal block partition in the block is to be ignored” 216. For example, say the current superblock size is 128×128 and a PARTITION_VERT is retrieved from the bitstream as the initial partition syntax for that superblock. In this case, the 128×128 superblock would be split into two 64×128 partition units according to the initial partition syntax. This partition syntax (or partition pattern) is illegal for the parent superblock. So in this case, the present method and system (or bitstream decoding logic or codec) overrides this illegal split. This is done by generating a second corrective partition syntax for decoding the superblock and that is legal instead. By one form, this may be any legal partition syntax, but by another approach, only the partition syntax PARTITION_NONE is used so that the parent block (whether a superblock or subblock) is not partitioned or divided at all for prediction decoding.

Also, all the logic downstream from the block with the corrective partition syntax will receive the syntax element equal to PARTITION_NONE such that the overridden conformed corrective partition syntax or element is used at the downstream subblock units of a superblock (or whichever parent block started the chain of overrides). Since all illegal splits imply only one more level of division of the current block, the decoding logic can override the current split as PARTITION_NONE to ensure the conformance of the syntax elements even though the bitstream is illegal.

By one form, the illegal partition syntax detection and generation of a second legal partition syntax to be used instead may be performed by a single unit that is operating a revised decode partition function code that has been modified to include instructions to handle the illegal partition syntax. Such function code may be activated by running a decode partition function, such as for AV1. Example revised pseudo code for this function is as follows.

### Key and Explanations

AV1 is operating on a 4×4 pixel grid, so that the origin of each partition must be passed to the decode_partition function.
r is the r-th row of 4×4 in the frame.
c is the c-th column of 4×4 in the frame.
Mirows is the number of 4×4 rows in the frame.
Micols is the number of 4×4 columns in the frame.
AvailU and AvailL are used for calculating the context of looking up common data format (CDF) tables for AV1 CABAC, and is not relevant here.
split_or_vert is used to compute partition for blocks when only split or vert partitions are allowed because of overlap with the right edge of the frame.
split_or_horz is used to compute partition for blocks when only split or horz partitions are allowed because of overlap with the bottom edge of the frame.

Table 3 below indicates block size (bsize) or subsize codes of a current partition.

TABLE 3
Block Size (bsize)

| subSize | Name of subSize |
|---|---|
| 0 | BLOCK_4 × 4 |
| 1 | BLOCK_4 × 8 |
| 2 | BLOCK_8 × 4 |
| 3 | BLOCK_8 × 8 |
| 4 | BLOCK_8 × 16 |
| 5 | BLOCK_16 × 8 |
| 6 | BLOCK_16 × 16 |
| 7 | BLOCK_16 × 32 |
| 8 | BLOCK_32 × 16 |
| 9 | BLOCK_32 × 32 |
| 10 | BLOCK_32 × 64 |
| 11 | BLOCK_64 × 32 |
| 12 | BLOCK_64 × 64 |
| 13 | BLOCK_64 × 128 |
| 14 | BLOCK_128 × 64 |
| 15 | BLOCK_128 × 128 |
| 16 | BLOCK_4 × 16 |
| 17 | BLOCK_16 × 4 |
| 18 | BLOCK_8 × 32 |
| 19 | BLOCK_32 × 8 |
| 20 | BLOCK_16 × 64 |
| 21 | BLOCK_64 × 16 |

EXAMPLE PSEUDO CODE FOR IGNORING ILLEGAL PARTITION:
(The bold and italic text is the modified code added to handle illegal partitions)

```
decode_partition( r, c, bSize, subsampling_x, subsampling_y) {
  if (r >= MiRows ∥ c >= MiCols )
    return 0
    AvailU = is_inside( r − 1, c)
    AvailL = is_inside( r, c − 1)
    num4x4 = Num_4x4_Blocks_Wide[ bSize ]
    halfBlock4x4 = num4x4 >> 1
    quarterBlock4x4 = halfBlock4x4 >> 1
    hasRows = ( r + halfBlock4x4 ) < MiRows
    hasCols = ( c + halfBlock4x4 ) < MiCols
    if ( bSize < BLOCK_8X8 ) {
      partition = PARTITION_NONE
    } else if ( hasRows && hasCols ) {
      partition // Syntax Element decoded from bitstream
    } else if ( hasCols ) {
      split_or_horz // Syntax Element decoded from bitstream
      partition = split_or_horz ? PARTITION_SPLIT : PARTITION_HORZ
  } else if ( hasRows ) {
    split_or_vert // Syntax Element decoded from bitstream
    partition = split_or_vert ? PARTITION_SPLIT : PARTITION_VERT
  } else {
    partition = PARTITION_SPLIT
  }
  // Beginning of Code for AV1 422 error handling
  if ((subsampling_x == 1) && (subsampling_y == 0)) {
    if ( bSize == BLOCK_8X8) {
      if (partition == PARTITION_VERT) {
        partition = PARTITION_NONE
      }
    } else if ((bSize == BLOCK_16X16) ∥ (bSize == BLOCK_32X32) ∥(bSize ==
BLOCK_64X64)) {
      if ((partition == PARTITION_VERT) ∥ (partition == PARTITION_VERT_A) ∥ (partition
== PARTITION_VERT_B) ∥ (partition == PARTITION_VERT_4)) {
        partition = PARTITION_NONE
      }
    } else if (bSize == BLOCK_128X128) {
      if ((partition == PARTITION_VERT) ∥ (partition == PARTITION_VERT_A) ∥ (partition
== PARTITION_VERT_B)) {
        partition = PARTITION_NONE
      }
    }
  }
  // End of Code for AV1 422 error handling
  subSize = Partition_Subsize[ partition ][ bSize ]
  splitSize = Partition_Subsize[ PARTITION_SPLIT ][ bSize ]
  if ( partition == PARTITION_NONE ) {
    decode_block( r, c, subSize )
  } else if ( partition == PARTITION_HORZ ) {
    decode_block( r, c, subSize )
  if ( hasRows )
    decode_block( r + halfBlock4x4, c, subSize )
  } else if ( partition == PARTITION_VERT ) {
    decode_block( r, c, subSize )
  if ( hasCols )
    decode_block( r, c + halfBlock4x4, subSize )
  } else if ( partition == PARTITION_SPLIT ) {
    decode_partition( r, c, subSize )
    decode_partition( r, c + halfBlock4x4, subSize )
    decode_partition( r + halfBlock4x4, c, subSize )
    decode_partition( r + halfBlock4x4, c + halfBlock4x4, subSize )
  } else if ( partition == PARTITION_HORZ_A ) {
    decode_block( r, c, splitSize )
    decode_block( r, c + halfBlock4x4, splitSize )
    decode_block( r + halfBlock4x4, c, subSize )
  } else if ( partition == PARTITION_HORZ_B ) {
    decode_block( r, c, subSize )
    decode_block( r + halfBlock4x4, c, splitSize )
    decode_block( r + halfBlock4x4, c + halfBlock4x4, splitSize )
} else if ( partition == PARTITION_VERT_A ) {
    decode_block( r, c, splitSize )
    decode_block( r + halfBlock4x4, c, splitSize )
    decode_block( r, c + halfBlock4x4, subSize )
} else if ( partition == PARTITION_VERT_B ) {
    decode_block( r, c, subSize )
    decode_block( r, c + halfBlock4x4, splitSize )
    decode_block( r + halfBlock4x4, c + halfBlock4x4, splitSize )
} else if ( partition == PARTITION_HORZ_4 ) {
    decode_block( r + quarterBlock4x4 * 0, c, subSize )
    decode_block( r + quarterBlock4x4 * 1, c, subSize )
    decode_block( r + quarterBlock4x4 * 2, c, subSize )
if ( r + quarterBlock4x4 * 3 < MiRows )
    decode_block( r + quarterBlock4x4 * 3, c, subSize )
} else {
    decode_block( r, c + quarterBlock4x4 * 0, subSize )
    decode_block( r, c + quarterBlock4x4 * 1, subSize )
    decode_block( r, c + quarterBlock4x4 * 2, subSize )
if ( c + quarterBlock4x4 * 3 < MiCols )
    decode_block( r, c + quarterBlock4x4 * 3, subSize )
}
}
```

It will be appreciated that alternatively, the retrieved initial partition code could be compared to the legal partition codes instead and determined to be illegal by process of elimination when desired.

Operation 214 may include “decode the block at least according to the second syntax” 218, and by decoding processes that use an AV1 codec standard in this example case although other standards may be used. The relevant details are provided above where the legal partition may be provided to prediction units to generate predictions to add to decompressed residuals, and in turn reconstruct decoded frames. The result is a set of decoded decompressed images of good quality and less drops or pauses due to illegal partitioning. The images are now ready to be provided to a display, stored, or further transmitted to another device for further analysis or processing.

While implementation of the example processes discussed herein may include the undertaking of all operations shown in the order illustrated for any methods herein, the present disclosure is not limited in this regard and, in various examples, implementation of the example processes herein may include only a subset of the operations shown, operations performed in a different order than illustrated, or additional operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the operations discussed herein and/or any portions of the devices, systems, or any module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

As used in any implementation described herein, the term “logic unit” refers to any combination of firmware logic and/or hardware logic configured to provide the functionality described herein. The logic units may, collectively or individually, be embodied as circuitry that forms part of a larger system, for example, an integrated circuit (IC), system on-chip (SoC), and so forth. For example, a logic unit may be embodied in logic circuitry for the implementation of firmware or hardware of the coding systems discussed herein. One of ordinary skill in the art will appreciate that operations performed by hardware and/or firmware may alternatively be implemented via software, which may be embodied as a software package, code and/or instruction set or instructions, and also appreciate that a logic unit also may utilize a portion of software to implement its functionality.

As used in any implementation described herein, the term “component” may refer to a module or to a logic unit, as these terms are described above. Accordingly, the term “component” may refer to any combination of software logic, firmware logic, and/or hardware logic configured to provide the functionality described herein. For example, one of ordinary skill in the art will appreciate that operations performed by hardware and/or firmware may alternatively be implemented via a software module, which may be embodied as a software package, code and/or instruction set, and also appreciate that a logic unit may also utilize a portion of software to implement its functionality. Component herein also may refer to processors and other specific hardware devices.

The terms “circuit” or “circuitry,” as used in any implementation herein, may comprise or form, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor (“processor circuitry”) and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices.

The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other implementations may be implemented as software executed by a programmable control device. In such cases, the terms “circuit” or “circuitry” are intended to include a combination of software and hardware such as a programmable control device or a processor capable of executing the software. As described herein, various implementations may be implemented using hardware elements, software elements, or any combination thereof that form the circuits, circuitry, processor circuitry. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

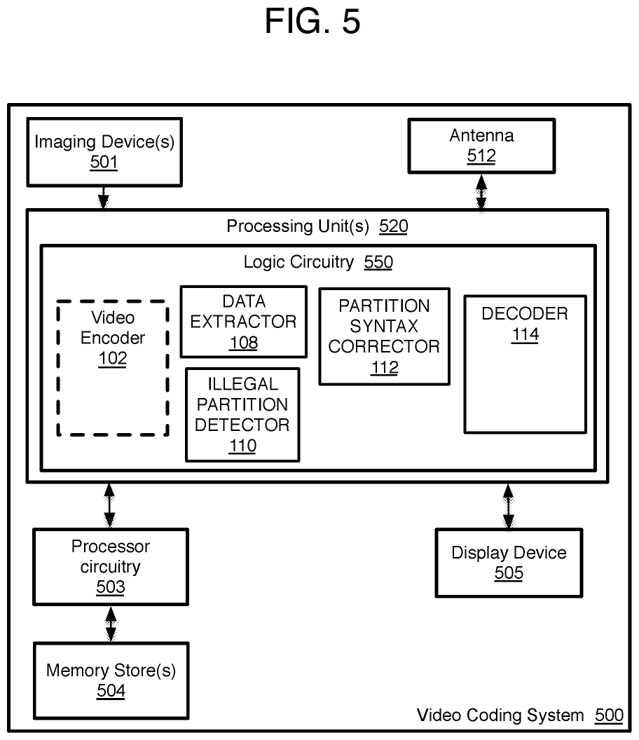

Referring to FIG. 5, an example video coding system 500 for providing video coding with illegal partition handling may be arranged in accordance with at least some implementations of the present disclosure. In the illustrated implementation, the system 500 may include an imaging device 501 or may be connected to a separate imaging device 501. By one form, the imaging device may be a video camera, still picture camera, or both, and the device 500 holds such a camera such as a smartphone, tablet, and so forth. By other examples, the device 500 is a camera, and the imaging device 501 is the hardware and sensors that form the image capturing components of the camera.

System 500 also may include one or more central and/or graphics processing circuitry 503 that forms processing units or processors including CPUs, ISPs, GPUs, and so forth, a display device 505, and one or more memory stores 504. Central processing units 503, memory store 504, and/or display device 505 may be capable of communication with one another, via, for example, a bus, wires, or other access. In various implementations, display device 505 may be integrated in system 500 or implemented separately from system 500.

The system 500 also may have an antenna 512 to receive or transmit image data, profile and syntax data, such as partition syntax, and other data related to video coding. Thus, in some cases, the imaging device 501 may not be the only source of the image data.

As shown in FIG. 5, and discussed above, the processing unit 520 may have logic circuitry 550 with, optionally, a video encoder 102, a data extractor 108, an entropy unit 110, an illegal partition detector 112, and a partition syntax corrector 114. The units may be part of a decoder 116 or the decoder 116 may be considered a separate unit. Thus, system 500 as shown may be either on the encoder side or decoder side for the system (or may alternatively act as either). These components may be respectively similar to the similarly named components on system 100 (FIG. 1) except that two devices 102 and 104 would be needed, one to act as the encoder and the other to act as the decoder. The video decoder 104 may have the illegal partition detector 112 to detect the illegal partition sizes and the partition corrector 114 to generate a corrective partition syntax to use for a large image block instead. It will be understood that the detection and corrector units 112 and 114 may be a single unit that operates decode partition function code that uses partition syntax as part of the decoder's operations as described above.

As will be appreciated, the modules or units illustrated in FIG. 5 may include a variety of software and/or hardware modules and/or modules that may be implemented via software or hardware or combinations thereof. For example, the modules may be implemented as software via processing units 520 or the modules may be implemented via a dedicated hardware portion. Furthermore, the shown memory stores 504 may be shared memory for processing units 520, for example. Image data, partition function and syntax data, and other video coding data may be stored on any of the options mentioned above, or may be stored on a combination of these options, or may be stored elsewhere. Also, system 500 may be implemented in a variety of ways. For example, system 500 (excluding display device 505) may be implemented as a single chip or device having a graphics processor, a quad-core central processing unit, and/or a memory controller input/output (I/O) module. In other examples, system 500 (again excluding display device 505) may be implemented as a chipset.

Processor(s) of processor circuitry 503 may include any suitable implementation including, for example, microprocessor(s), multicore processors, application specific integrated circuits, chip(s), chipsets, programmable logic devices, graphics cards, integrated graphics, general purpose graphics processing unit(s), or the like. In addition, memory stores 504 may be any type of memory such as volatile memory (e.g., Static Random Access Memory (SRAM), Dynamic Random Access Memory (DRAM), etc.) or non-volatile memory (e.g., flash memory, etc.), and so forth. In a non-limiting example, memory stores 504 also may be implemented via cache memory.

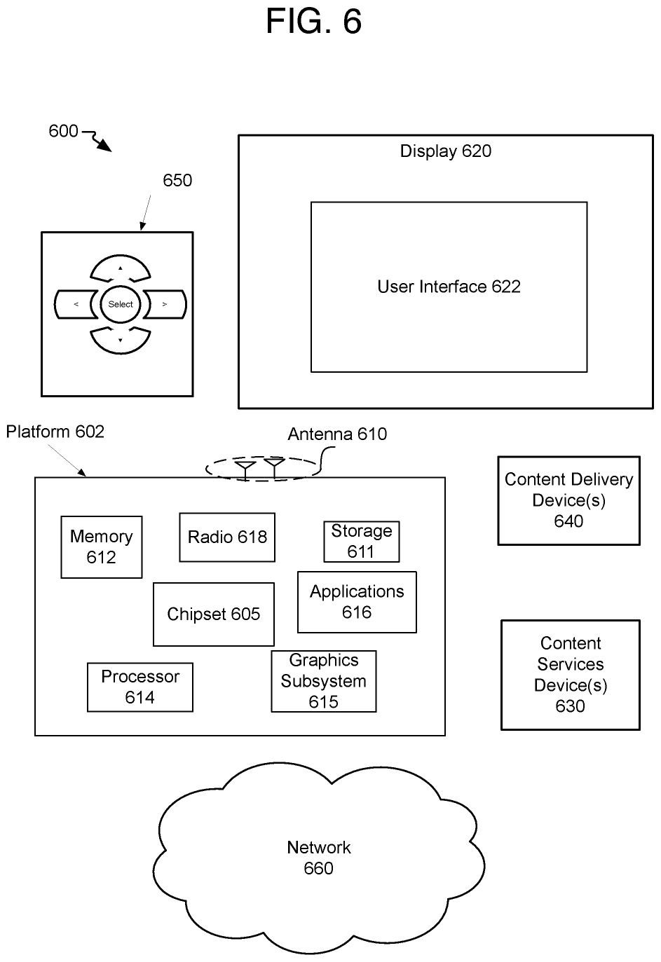

Referring to FIG. 6, an example system 600 in accordance with the present disclosure and various implementations, may be a media system although system 600 is not limited to this context. For example, system 600 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In various implementations, system 600 includes a platform 602 communicatively coupled to a display 620. Platform 602 may receive content from a content device such as content services device(s) 630 or content delivery device(s) 640 or other similar content sources. A navigation controller 650 including one or more navigation features may be used to interact with, for example, platform 602 and/or display 620. Each of these components is described in greater detail below.

In various implementations, platform 602 may include any combination of a chipset 605, processor 614, memory 612, storage 611, graphics subsystem 615, applications 616 and/or radio 618 as well as antenna(s) 610. Chipset 605 may provide intercommunication among processor 614, memory 612, storage 611, graphics subsystem 615, applications 616 and/or radio 618. For example, chipset 605 may include a storage adapter (not depicted) capable of providing intercommunication with storage 611.

Processor 614 may be implemented as a Complex Instruction Set Computer (CISC) or Reduced Instruction Set Computer (RISC) processors; x86 instruction set compatible processors, multi-core, or any other microprocessor or central processing unit (CPU). In various implementations, processor 614 may be dual-core processor(s), dual-core mobile processor(s), and so forth.

Memory 612 may be implemented as a volatile memory device such as, but not limited to, a Random Access Memory (RAM), Dynamic Random Access Memory (DRAM), or Static RAM (SRAM).

Storage 611 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 611 may include technology to increase the storage performance enhanced protection for valuable digital media when multiple hard drives are included, for example.

Graphics subsystem 615 may perform processing of images such as still or video for display. Graphics subsystem 615 may be a graphics processing unit (GPU) or a visual processing unit (VPU), for example. An analog or digital interface may be used to communicatively couple graphics subsystem 615 and display 620. For example, the interface may be any of a High-Definition Multimedia Interface, Display Port, wireless HDMI, and/or wireless HD compliant techniques. Graphics subsystem 615 may be integrated into processor 614 or chipset 605. In some implementations, graphics subsystem 615 may be a stand-alone card communicatively coupled to chipset 605.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In other implementations, the functions may be implemented in a consumer electronics device.

Radio 618 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 618 may operate in accordance with one or more applicable standards in any version.

In various implementations, display 620 may include any television type monitor or display. Display 620 may include, for example, a computer display screen, touch screen display, video monitor, television-like device, and/or a television. Display 620 may be digital and/or analog. In various implementations, display 620 may be a holographic display. Also, display 620 may be a transparent surface that may receive a visual projection. Such projections may convey various forms of information, images, and/or objects. For example, such projections may be a visual overlay for a mobile augmented reality (MAR) application. Under the control of one or more software applications 616, platform 602 may display user interface 622 on display 620.

In various implementations, content services device(s) 630 may be hosted by any national, international and/or independent service and thus accessible to platform 602 via the Internet, for example. Content services device(s) 630 may be coupled to platform 602 and/or to display 620. Platform 602 and/or content services device(s) 630 may be coupled to a network 660 to communicate (e.g., send and/or receive) media information to and from network 660. Content delivery device(s) 640 also may be coupled to platform 602 and/or to display 620.

In various implementations, content services device(s) 630 may include a cable television box, personal computer, network, telephone, Internet enabled devices or appliance capable of delivering digital information and/or content, and any other similar device capable of unidirectionally or bidirectionally communicating content between content providers and platform 602 and/display 620, via network 660 or directly. It will be appreciated that the content may be communicated unidirectionally and/or bidirectionally to and from any one of the components in system 600 and a content provider via network 660. Examples of content may include any media information including, for example, video, music, medical and gaming information, and so forth.

Content services device(s) 630 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 602 may receive control signals from navigation controller 650 having one or more navigation features. The navigation features of controller 650 may be used to interact with user interface 622, for example. In implementations, navigation controller 650 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 650 may be replicated on a display (e.g., display 620) by movements of a pointer, cursor, focus ring, or other visual indicators displayed on the display. For example, under the control of software applications 616, the navigation features located on navigation controller 650 may be mapped to virtual navigation features displayed on user interface 622, for example. In implementations, controller 650 may not be a separate component but may be integrated into platform 602 and/or display 620. The present disclosure, however, is not limited to the elements or in the context shown or described herein.

In various implementations, drivers (not shown) may include technology to enable users to instantly turn on and off platform 602 like a television with the touch of a button after initial boot-up, when enabled, for example. Program logic may allow platform 602 to stream content to media adaptors or other content services device(s) 630 or content delivery device(s) 640 even when the platform is turned “off.” In addition, chipset 605 may include hardware and/or software support for 7.1 surround sound audio and/or high definition (7.1) surround sound audio, for example. Drivers may include a graphics driver for integrated graphics platforms. In implementations, the graphics driver may comprise a peripheral component interconnect (PCI) Express graphics card.

In various implementations, any one or more of the components shown in system 600 may be integrated. For example, platform 602 and content services device(s) 630 may be integrated, or platform 602 and content delivery device(s) 640 may be integrated, or platform 602, content services device(s) 630, and content delivery device(s) 640 may be integrated, for example. In various implementations, platform 602 and display 620 may be an integrated unit. Display 620 and content service device(s) 630 may be integrated, or display 620 and content delivery device(s) 640 may be integrated, for example. These examples are not meant to limit the present disclosure.

In various implementations, system 600 may be implemented as a wireless system, a wired system, or a combination of both. When implemented as a wireless system, system 600 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 600 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 602 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The implementations, however, are not limited to the elements or in the context shown or described in FIG. 6.

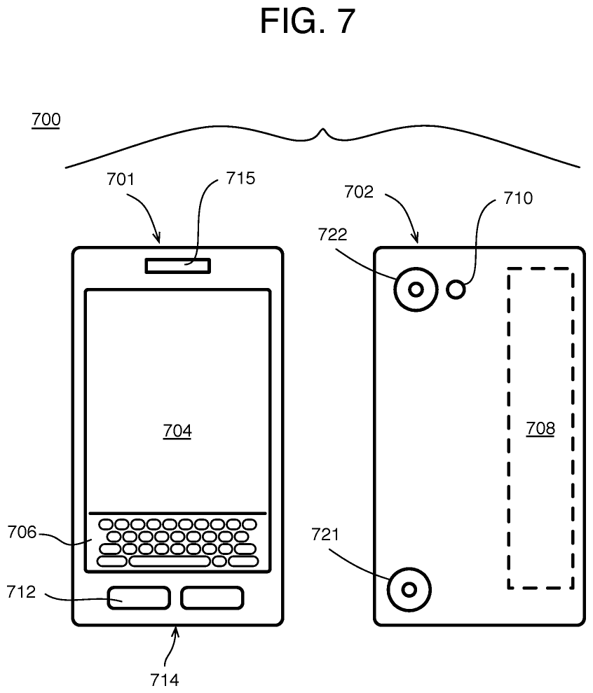

As described above, system 600 may be embodied in varying physical styles or form factors. FIG. 7 illustrates an example small form factor device 700, arranged in accordance with at least some implementations of the present disclosure. In some examples, system 500 or 600 may be implemented via device 700. In other examples, other systems, components, or modules discussed herein or portions thereof may be implemented via device 700. In various implementations, for example, device 700 may be implemented as a mobile computing device having wireless capabilities. A mobile computing device may refer to any device having a processing system and a mobile power source or supply, such as one or more batteries, for example.

Examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, smart device (e.g., smartphone, smart tablet or smart mobile television), mobile internet device (MID), messaging device, data communication device, cameras (e.g. point-and-shoot cameras, super-zoom cameras, digital single-lens reflex (DSLR) cameras), and so forth.

Examples of a mobile computing device also may include computers that are arranged to be implemented by a motor vehicle or robot, or worn by a person, such as wrist computers, finger computers, ring computers, eyeglass computers, belt-clip computers, arm-band computers, shoe computers, clothing computers, and other wearable computers. In various implementations, for example, a mobile computing device may be implemented as a smartphone capable of executing computer applications, as well as voice communications and/or data communications. Although some implementations may be described with a mobile computing device implemented as a smartphone by way of example, it may be appreciated that other implementations may be implemented using other wireless mobile computing devices as well. The implementations are not limited in this context.

As shown in FIG. 7, device 700 may include a housing with a front 701 and a back 702. Device 700 includes a display 704, an input/output (I/O) device 706, a camera 721, a camera 722, and an integrated antenna 708. In some implementations, device 700 does not include cameras 721 and 722, and device 700 attains input image data (e.g., any input image data discussed herein) from another device. Device 700 also may include navigation features 712. I/O device 706 may include any suitable I/O device for entering information into a mobile computing device. Examples for I/O device 706 may include an alphanumeric keyboard, a numeric keypad, a touch pad, input keys, buttons, switches, microphones 714, speakers 715, voice recognition device and software, and so forth. Information also may be entered into device 700 by way of microphone (not shown), or may be digitized by a voice recognition device. As shown, device 700 may include cameras 721, 722, and a flash 710 integrated into back 702 (or elsewhere) of device 700. In other examples, cameras 721, 722, and flash 710 may be integrated into front 701 of device 700 or both front and back sets of cameras may be provided.

Various implementations may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an implementation is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one implementation may be implemented by representative instructions stored on a machine-readable medium which represents various logic within the processor, which when read by a machine causes the machine to fabricate logic to perform the techniques described herein. Such representations, known as IP cores may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to additional implementations.

By an example 1, a computer-implemented method of video coding, comprising: receiving compressed image data of video frames including a block of image data of at least one of the frames; receiving first partition data, the first partition data to decode the compressed image data and to indicate a partition in the block; detecting whether or not the block has an illegal block partition; generating second partition data, the second partition data to indicate the illegal block partition of the block is to be ignored; and decoding the block based on the second partition data.

By an example 2, the subject matter of example 1, wherein the first and second partition data are respectively a first and second partition syntax of a video coding codec.

By an example 3, the subject matter of example 2, wherein the codec is AO Media Audio Visual 1 (AV1).

By an example 4, the subject matter of example 3, wherein the second partition syntax is a code of partition_none.

By an example 5, the subject matter of any one of examples 1 to 4, wherein the second partition data is to further indicate that any partition of the block should be omitted for prediction.

By an example 6, the subject matter of any one of examples 1 to 5, wherein the first partition data is received in a compressed state in a bitstream with the compressed image data, and wherein the second partition data is generated at a decoding device that receives the bitstream.

By an example 7, the subject matter of any one of examples 1 to 6, wherein the detecting comprises determining a block size of the block, determining a partition pattern of the first partition data to subdivide the block, and determining whether the partition pattern is the same as one or more illegal partition patterns associated with the block size.

By an example 8, at least one article comprising a computer-readable medium having instructions thereon that when executed cause a computing device to operate by: receiving compressed image data of video frames, including a block of image data of at least one of the frames; receiving a partition syntax of a video coding codec, the partition syntax to decode the compressed image data and to indicate a partition in the block; detecting whether or not the block has an illegal block partition; generating a corrective partition syntax of the video coding codec, the corrective partition syntax to indicate the illegal block partition of the block is to be ignored; and decoding the block based on the corrective partition syntax.

By an example 9, the subject matter of example 8, wherein the illegal block partition at least partly depends on a chroma subsampling format of the image data.

By an example 10, the subject matter of example 8 or 9, wherein the illegal block partition at least partly depends on a size of the block and a predetermined set of legal partition patterns depending on the block size.

By an example 11, the subject matter of any one of examples 8 to 10, wherein the corrective partition syntax indicates a legal partition pattern according to the codec.

By an example 12, the subject matter of any one of examples 8 to 11, wherein the corrective partition syntax indicates the at least one block is to be prediction decoded without a partition.

By an example 13, the subject matter of any one of examples 8 to 12, wherein the corrective partition syntax indicates a legal partition pattern of the block that has at least one partition.

By an example 14, the subject matter of any one of examples 8 to 13, wherein the detecting and generating includes running revised decode partition function code of AV1 codec that changes a partition syntax when an illegal partition is detected.

By an example 15, A computer-implemented system of video coding, comprising: memory; and processor circuitry communicatively connected to the memory, wherein the processor circuitry is arranged to operate by: encoding image data of a video sequence of frames and at least one block of at least one of the frames; and placing the encoded image data and a first partition data into a bitstream, wherein the first partition data indicates a block partition of the at least one block; and transmitting the bitstream to a decoder, wherein the decoder is arranged to detect whether or not the block partition is an illegal partition and generate a corrective partition that indicates whether the block partition is to be ignored to decode the block when the block partition is an illegal partition.

By an example 16, the subject matter of example 15, wherein the detecting comprises running decode partition function code having instructions to receive a block size of the at least one block and compare a first partition syntax of the first partition data to illegal or legal partitions of the at least one block having the block size.

By an example 17, the subject matter of example 16, wherein when the block size is 8×8 pixels, the illegal partition has a single vertical divide entirely between two blocks, wherein when the block size is 16×16, 32×32, or 64×64 pixels, the illegal partitions have at least one vertical linear divide entirely through the block except for a split that divides the block into four quadrant blocks, and wherein when the block size is 128×128, the illegal partitions have a single vertical linear divide entirely through the block and a single horizontal divide halfway through the block.

By an example 18, the subject matter of example 16, wherein the detecting is performed by running revised decode partition function code that was modified to handle the illegal partition.

By an example 19, the subject matter of any one of examples 15 to 18, wherein the decoder comprises a partition unit that receives the corrective partition to generate prediction partitions.

By an example 20, the subject matter of any one of examples 15 to 19, wherein the corrective partition indicates partition of the at least one block should be omitted for prediction at the decoder.

In another example, at least one machine readable medium may include a plurality of instructions that in response to being executed on a computing device, cause the computing device to perform the method according to any one of the above examples.

In yet another example, an apparatus may include means for performing the methods according to any one of the above examples.

The above examples may include specific combination of features. However, the above examples are not limited in this regard and, in various implementations, the above examples may include undertaking only a subset of such features, undertaking a different order of such features, undertaking a different combination of such features, and/or undertaking additional features than those features explicitly listed. For example, all features described with respect to the example methods may be implemented with respect to the example apparatus, the example systems, and/or the example articles, and vice versa.

What is claimed is:

1. A computer-implemented method of video coding, comprising:
receiving compressed image data of video frames including a block of image data of at least one of the frames;
receiving first partition data, the first partition data to decode the compressed image data and to indicate a partition in the block;
detecting whether or not the block has an illegal block partition;
generating second partition data, the second partition data to indicate the illegal block partition of the block is to be ignored; and
decoding the block based on the second partition data.

2. The method of claim 1, wherein the first and second partition data are respectively a first and second partition syntax of a video coding codec.

3. The method of claim 2, wherein the codec is AO Media Audio Visual 1 (AV1).

4. The method of claim 3, wherein the second partition syntax is a code of partition_none.

5. The method of claim 1, wherein the second partition data is to further indicate that any partition of the block should be omitted for prediction.

6. The method of claim 1, wherein the first partition data is received in a compressed state in a bitstream with the compressed image data, and wherein the second partition data is generated at a decoding device that receives the bitstream.

7. The method of claim 1, wherein the detecting comprises determining a block size of the block, determining a partition pattern of the first partition data to subdivide the block, and determining whether the partition pattern is the same as one or more illegal partition patterns associated with the block size.

8. At least one article comprising a computer-readable medium having instructions thereon that when executed cause a computing device to operate by:
receiving compressed image data of video frames, including a block of image data of at least one of the video frames;
receiving a partition syntax of a video coding codec, the partition syntax to decode the compressed image data and to indicate a partition in the block;
detecting whether or not the block has an illegal block partition;
generating a corrective partition syntax of the video coding codec, the corrective partition syntax to indicate the illegal block partition of the block is to be ignored; and
decoding the block based on the corrective partition syntax.

9. The medium of claim 8, wherein the illegal block partition at least partly depends on a chroma subsampling format of the image data.

10. The medium of claim 8, wherein the illegal block partition at least partly depends on a size of the block and a predetermined set of legal partition patterns depending on the block size.

11. The medium of claim 8, wherein the corrective partition syntax indicates a legal partition pattern according to the codec.

12. The medium of claim 8, wherein the corrective partition syntax indicates the at least one block is to be prediction decoded without a partition.

13. The medium of claim 8, wherein the corrective partition syntax indicates a legal partition pattern of the block that has at least one partition.

14. The medium of claim 8, wherein the detecting and generating includes running revised decode partition function code of AV1 codec that changes a partition syntax when an illegal partition is detected.

15. A computer-implemented system of video coding, comprising:
memory; and
processor circuitry communicatively connected to the memory, wherein the processor circuitry is arranged to operate by:
encoding image data of a video sequence of frames and at least one block of at least one of the frames; and
placing the encoded image data and a first partition data into a bitstream, wherein the first partition data indicates a block partition of the at least one block; and
transmitting the bitstream to a decoder, wherein the decoder is arranged to detect whether or not the block partition is an illegal partition and generate a corrective partition that indicates whether the block partition is to be ignored to decode the block when the block partition is an illegal partition.

16. The system of claim 15, wherein the detecting comprises running decode partition function code having instructions to receive a block size of the at least one block and compare a first partition syntax of the first partition data to illegal partitions of the at least one block having the block size.

17. The system of claim 16, wherein when the block size is 8×8 pixels, the illegal partition has a single vertical divide entirely between two blocks,
wherein when the block size is 16×16, 32×32, or 64×64 pixels, the illegal partitions have at least one vertical linear divide entirely through the block except for a split that divides the block into four quadrant blocks, and
wherein when the block size is 128×128, the illegal partitions have a single vertical linear divide entirely through the block and a single horizontal divide halfway through the block.

18. The system of claim 16, wherein the detecting is performed by running revised decode partition function code that was modified to handle the illegal partition.

19. The system of claim 15, wherein the decoder comprises a partition unit that receives the corrective partition to generate prediction partitions.

20. The system of claim 15, wherein the corrective partition indicates partition of the at least one block should be omitted for prediction at the decoder.
